(19) United States
(12) Patent Application Publication
(10) Pub. No.: US 2013/0204859 A1
(43) Pub. Date: Aug. 8, 2013

(54) PROVIDING TEMPORAL BIAS FOR SEARCH-RESULT-WEBPAGE ITEMS

(71) Applicants: Deepak Vijaywargi, Bellevue, WA (US); I-Ting Fang, Bellevue, WA (US)

(72) Inventors: Deepak Vijaywargi, Bellevue, WA (US); I-Ting Fang, Bellevue, WA (US)

(73) Assignee: MICROSOFT CORPORATION, Redmond, WA (US)

(21) Appl. No.: 13/366,501

(22) Filed: Feb. 6, 2012

(51) Int. Cl. G06F 17/30

(52) U.S. Cl. 707/709; 707/E17.108

(57) ABSTRACT

A method, system, and medium are provided to temporally bias items included in a search results webpage. The items include navigational links, search results, advertisements, or any other content or items included in a search results webpage. User engagement with the items via the search-engine results page and/or other webpages is tracked. A user-engagement score and an age of the items are determined. A temporal-bias factor is calculated using a decay function that increases in intensity with the age of the items. A rank score is calculated for each item based on the user-engagement score and the temporal-bias factor—the temporal-bias factor decreasing the rank score as a function of the age of the items. The items are ranked based at least in part on the rank score and one or more of the items are chosen for presentation in a search-engine results page.

### SUMMARY

Embodiments of the invention are defined by the claims below, not this summary. A high-level overview of various aspects of the invention are provided here for that reason, to provide an overview of the disclosure, and to introduce a selection of concepts that are further described in the Detailed-Description section below. This summary is not intended to identify key features or essential features of the claimed subject matter, nor is it intended to be used as an aid in isolation to determine the scope of the claimed subject matter. In brief and at a high level, this disclosure describes, among other things, ways to temporally bias items included in a search results webpage. The items include search results, links, advertisements, or any other content or items included in a search results webpage.

User engagement with the items is tracked. The user engagement can be via the search engine results webpage or via other locations at which the items are accessible, e.g. webpages in which the items are published. A user-engagement score and an age of the items are determined. A temporal-bias factor is calculated using a decay function that increases in intensity with the age of the items. A rank score is calculated for each item based on the user-engagement score and the temporal-bias factor—the temporal-bias factor decreases the rank score as a function of the age of the items. The items are ranked based at least in part on the rank score and one or more of the items are chosen for presentation in a search results webpage.

The temporal-bias factor may aid in adjusting the rank score for older items, for which a greater quantity of user-engagement data is available, downward to allow newer items, for which little to no user-engagement data is available, to be ranked higher. Thus, newer, upward-trending items for which users may have greater interest can be ranked above older, potentially stale items.

### DESCRIPTION OF THE DRAWINGS

Illustrative embodiments of the invention are described in detail below with reference to the attached drawing figures, and wherein:

FIG. 1 is a block diagram depicting an exemplary computing device that is suitable for use in embodiments of the invention;

FIG. 2 is a block diagram depicting an exemplary computing environment suitable for use in embodiments of the invention;

FIG. 3 is a flow diagram depicting a method of generating a temporal bias for an item in a search results webpage in accordance with an embodiment of the invention;

FIG. 4 is a graph depicting plots of decay functions showing intensity of the decay function versus age of an item in accordance with an embodiment of the invention;

FIG. 5 is a block diagram depicting a system for increasing the freshness of items selected for inclusion in a search results webpage in accordance with an embodiment of the invention;

FIG. 6 is a flow diagram depicting a method of generating navigational links with temporal bias in accordance with an embodiment of the invention; and

FIG. 7 is a graphical illustration depicting an exemplary search results webpage in accordance with an embodiment of the invention.

### DETAILED DESCRIPTION

The subject matter of select embodiments of the invention is described with specificity herein to meet statutory requirements. But the description itself is not intended to necessarily limit the scope of claims. Rather, the claimed subject matter might be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described.

Embodiments of the invention include methods, systems, and computer-readable media for providing a temporal bias for items that are included in a search results webpage. The items are described herein as comprising navigational links that are associated with a search result listing. But the items can comprise any item found in a search results webpage for which a temporal bias might be used to rank and/or identify those items for inclusion and placement in the search results webpages. Such items include, for example and not limitation, search results, advertisements, related search links, proposed search terms/query refinements, and the like.

Navigational links comprise links or hyperlinks, such as uniform-resource locators (URLs), uniform-resource identifiers (URIs), or any other link useable to locate a webpage or other content on a network or stored in a computer memory. Navigational links include links that are found in a first webpage and when executed, such as by a user clicking or selecting the link, direct the user's browser to a second webpage. For example, a first webpage might be a home page of a corporation. The home page might include navigational links like “Customer Support,” “Products,” “Contact Us,” or the like that link to subsequent webpages that include associated content. Navigational links can link to any subsequent webpages that are or are not associated with the first webpage, e.g. a navigational link on a manufacturer's website can link to other webpages of the manufacturer's website or to websites associated with other manufacturers, retail outlets, government agencies, or any variety of other webpages, documents, or content.

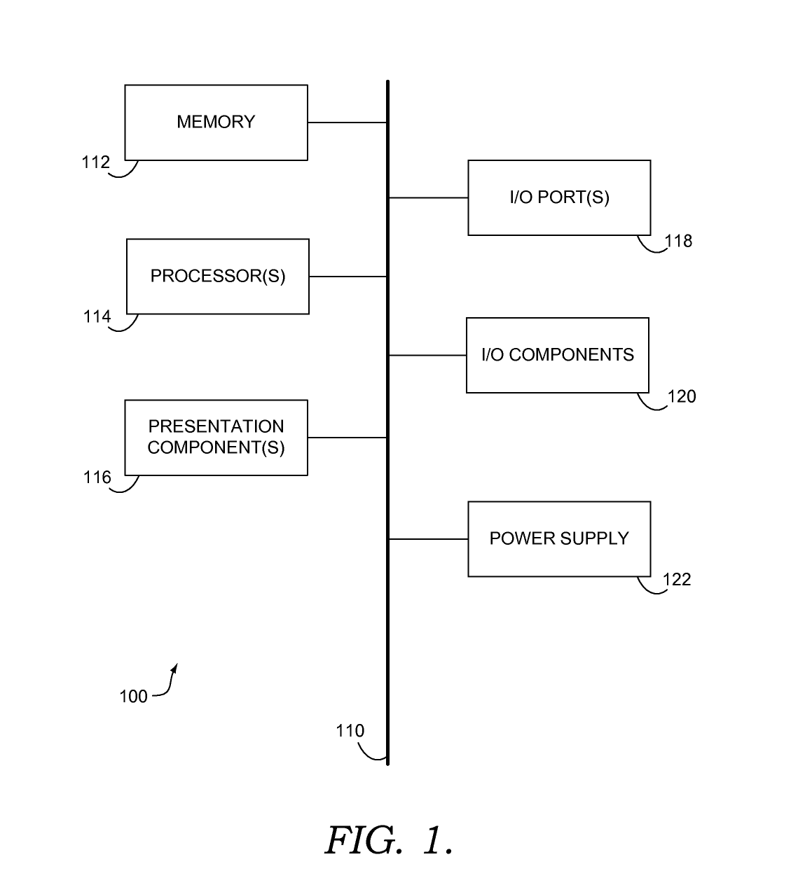

Referring initially to FIG. 1 in particular, an exemplary operating environment for implementing embodiments of the invention is shown and designated generally as a computing device 100. The computing device 100 is but one example of a suitable computing device and is not intended to suggest any limitation as to the scope of use or functionality of embodiments of the invention. Neither should the computing device 100 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Embodiments of the invention may be practiced in a variety of system configurations, including hand-held devices, consumer electronics, general-purpose computers, more specialty computing devices, etc. Embodiments of the invention may also be practiced in distributed computing environments where tasks are performed by remote-processing devices that are linked through a communications network.

With reference to FIG. 1, the computing device 100 includes a bus 110 that directly or indirectly couples the following devices: a memory 112, one or more processors 114, one or more presentation components 116, one or more input/output ports 118, one or more input/output components 120, and an illustrative power supply 122. The bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. It is recognized that such is the nature of the art—the diagram of FIG. 1 is merely illustrative of an exemplary computing device 100 that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media. Computer-readable media include computer-storage media and computer-storage devices and are mutually exclusive of communication media, e.g. carrier waves, signals, and the like. By way of example, and not limitation, computer-readable media may comprise Random Access Memory (RAM); Read-Only Memory (ROM); Electronically Erasable Programmable Read-Only Memory (EEPROM); flash memory or other memory technologies; compact disc read-only memory (CDROM), digital versatile disks (DVD) or other optical or holographic media; magnetic cassettes, magnetic tape, magnetic disk storage or other magnetic storage devices, or any other medium that can be used to encode desired information and be accessed by computing device 100.

The memory 112 includes computer-storage media in the form of volatile and/or nonvolatile memory. The memory 112 may be removable, non-removable, or a combination thereof. Exemplary hardware devices include solid-state memory, hard drives, optical-disc drives, etc. The computing device 100 includes one or more processors that read data from various entities such as the memory 112 or the I/O components 120. The presentation component(s) 116 present data indications to a user or other device. Exemplary presentation components include a display device, speaker, printing component, vibrating component, etc.

The I/O ports 118 allow the computing device 100 to be logically coupled to other devices including the I/O components 120, some of which may be built in. Illustrative components include a microphone, joystick, game pad, satellite dish, scanner, printer, wireless device, etc.

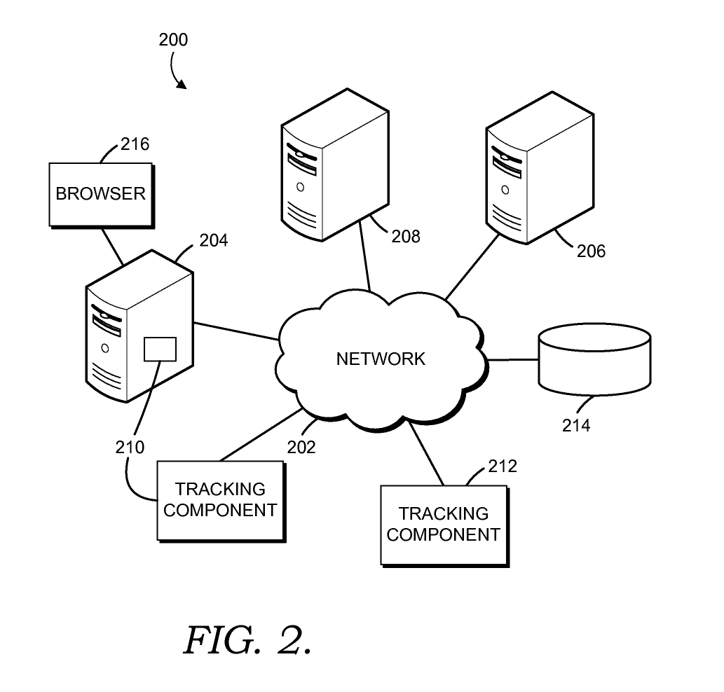

Referring now to FIG. 2, a block diagram of an exemplary network environment suitable for use in implementing embodiments of the invention is generally designated as numeral 200. The network environment 200 depicted in FIG. 2 is only one exemplary environment—of which there may be many—suitable for implementing embodiments of the invention. The components depicted in FIG. 2 are depicted singularly for clarity and are provided with names for reference but, one of ordinary skill in the art will recognize that a plurality of similar components may be used in application and that the nomenclature for the components may change without distracting from the functions described herein. For example, millions of computing devices might be accessing or connected to a network. Further, the nomenclature applied to a particular component in the environment 200 may change with respect to functions being performed thereby.

The environment 200 includes a network 202, a user's computing device 204, a search-engine server 206, a webpage server 208, a tracking component 210, a ranking component 212, and a data-store 214. The network is any available computing or communications network such as, for example, and not limitation, the Internet, an intranet, a local-area network (LAN), a wireless-access network (WAN), and combinations thereof. The user's computing device 204, the search-engine server 206, and the webpage server 208 comprise any one or more computing devices, such as the computing device 100 described above. Each of the devices 204, 206, and 208 is configured to access the network 202 and to communicate/receive data from other computing devices via the network 202 as is known in the art. Further detail of the devices 204, 206, and 208 in addition to that provided below, is not necessary for understanding and describing embodiments of the invention and, as such, is not provided herein.

The user's device 204 includes a browser application 216 (also referred to herein as a browser 216). The browser 216 is any browser application now known or later developed that is configurable to access documents via the network 202 such as web pages, websites, domains, folders, files, and the like. In an embodiment, the browser 216 comprises Internet Explorer® from Microsoft Corporation of Redmond, Wash., U.S.A., or Firefox® from Mozilla Corporation of Mountain View, Calif., U.S.A., among others. The browser 216 may use a search engine to identify and/or aid in accessing these documents.

The documents are accessed by the browser 216 using an address or locator such as a web address, URL, URI, internet protocol (IP) address, or another indication of the documents or their location in the network. The address or location of documents on the network is referred to herein as a URL, however, such is not intended to limit embodiments of the invention to use of a URL specifically—any indicator of document location is useable in embodiments of the invention.

With continued reference to FIG. 2, the search-engine server 206 provides a search engine that receives and executes search queries from users on the network 202, such as via the user device 204, as is known in the art. The search engine may employ any searching methods, indexing, caching, or other features or components desired. Additional details of the search engine and search-engine server 206 are not necessary for describing and understanding embodiments of the invention and are not described further herein.

The webpage server 208 includes any server or other computing device connected to the network 202 that provides webpage content to the user device 204 as is known in the art. Additional details of the webpage server 208 are not necessary for describing and understanding embodiments of the invention and are not described further herein.

The tracking component 210 is configured to track a user's web-browsing activities on the user device 204. The tracking component 210 can be a stand-alone component that is executed by a computing device, such as the computing device 100, connected to the network 202. In an embodiment, the tracking component 210 is executed by one or more computing devices associated with the search-engine server 206. Or the tracking component 210 can be installed on the user device 204 as a stand-alone component application, as a plug-in to another application, or in any other desired configuration. In an embodiment, the tracking component 210 is a plug-in to the browser application 216 executing on the user's computing device 204.

The tracking component 210 tracks any desired activities associated with a user's web browsing. For example, the tracking component 210 might track the webpages visited, the links clicked on those webpages, an amount of time the user spends on the webpages and the linked-to webpages, whether the user clicked a back button or returned to a webpage from which a link was clicked, a number of impressions of a link a user is exposed to, and the like. Such activities with respect to links and other items are described herein as user engagement with those items. The tracking component 210 tracks the user engagement with respect to time, e.g. when the activities occurred and rates of such occurrences. In an embodiment, the tracking component 210 tracks user engagement for a plurality of users.

The user engagement data is stored by the tracking component 210 in one or more computer memories, such as the datastore 214 on the network 202. The user engagement data might also be stored in a memory at the user device 204 or in any other available memory location. The datastore 214 comprises any available computer memory technology and can be a standalone component or integrated into one or more other components or devices. Additional details of the datastore 214 are not necessary for describing and understanding embodiments of the invention and are not described further herein.

The ranking component 212 is configured to calculate a rank score for the links included in the webpages served by the webpage server 208 as described below. In an embodiment, the ranking component 212 is configured to calculate a rank score for any items that might be included in a search-engine results page. The ranking component 212 is a stand-along component executed by a computing device. Or the ranking component 212 can be integrated or associated with the search-engine server 206 or other computing device on the network 202. The ranking component 212 may calculate the rank score off line on a periodic basis and provide updates to the search-engine server 206 for serving search-engine results pages. The ranking component 212 might calculate rank scores in real time or at run-time to instruct ranking of links or other items included in search-engine results pages by the search-engine server 206.

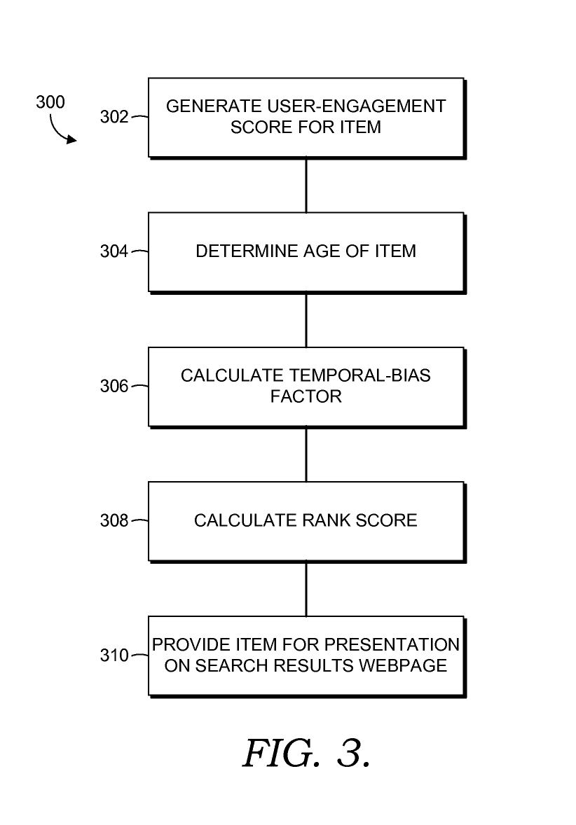

With reference now to FIG. 3, a method 300 for generating a temporal bias for an item in a search-engine results page is described in accordance with an embodiment of the invention. As described previously, the item comprises any item that can be included in a search engine results page, such as, for example, a navigational link, a search result, an advertisement, an additional query, or the like. At a step 302 a user-engagement score is generated for an item, such as a navigational link. The user-engagement score is calculated in any desired manner and provides an indication of user interest in the item. For example, a navigational link that has a large number of clicks as compared to other navigational links located on the same webpage is indicated to have greater user interest than those other links.

In an embodiment, the user-engagement score is calculated for one or more periods of time. The user-engagement score might be calculated based on user-engagement data collected over the past week, month, year, multiple years, or any other time increment. It may be useful to calculate the user-engagement score based on time increments of at least a week so as to avoid any variance between days of the week, e.g. browsing habits of users on weekdays might be considerably different than their browsing habits on the weekend.

In an embodiment, the user-engagement score is calculated based on a comparison between two different time periods. For example, the user-engagement data for a previous year is compared to user-engagement data for a previous month. As such, the user-engagement score might identify an item as trending upward, downward, or remaining static. The user-engagement score can comprise any numeric value, such as a percentage, a ratio, a rate of change, a slope, or any other desired value that is useable to describe the user-engagement with the item.

At a step 304, an age of the item is determined. The age of the item might be based on the date that the tracking component 210, ranking component 212, or search-engine server 206 became aware of the item. Or the age of the item might be based on the date of a most recent update to the item or any other useable measure of the age of the item. The age of the item can be described in any increment of time, e.g. days, weeks, months, etc.

A temporal-bias factor is calculated at a step 306. The temporal-bias factor is calculated using an equation that describes a decaying value based on one or more variables, e.g. a decay equation. In an embodiment, the decay equation describes an exponentially decaying value. The temporal-bias factor is based on available parameters collected in the user-engagement data; these include for example and not limitation, age of the item, duration of time a linked-to page is viewed, and the current time of day, year, week, or season.

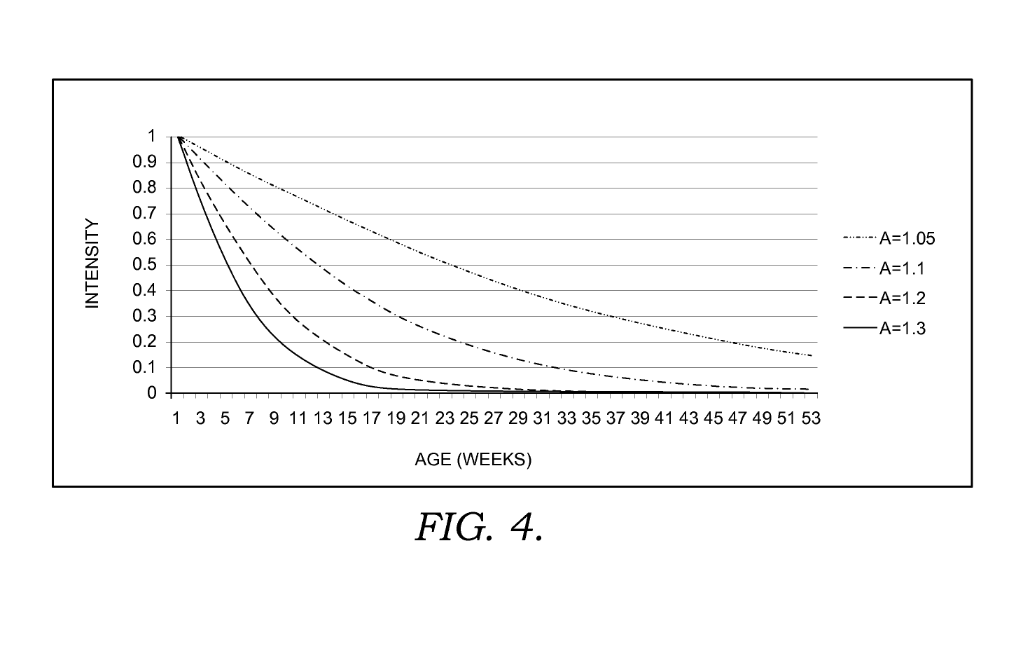

The temporal-bias factor is also based on an aggressiveness factor (A) that is selectable to control the intensity of the decay function. For example, a more aggressive or greater value of the aggressiveness factor will increase the intensity of the decay function, thereby increasing the rate at which the function goes toward a zero value. Conversely, a more conservative or smaller value of the aggressiveness factor results in a slower rate of decay. In an embodiment, the aggressiveness factor is between about 0.0 and about 3.0, or is between about 1.0 and about 1.5, or is between about 1.05 and about 1.3. In an embodiment, the aggressiveness factor is chosen from the values 1.05, 1.1, 1.2, and 1.3. FIG. 4 depicts exemplary plots of the temporal-bias factor (y-axis) for four exemplary values of the aggressiveness factor with respect to the age of the item (x-axis). As depicted in FIG. 4, greater values of the aggressiveness factor cause the decay function output to move toward an asymptote value of zero at a greater rate than lesser values.

In an embodiment, the decay function is of the form f(t)=1/(1+Ât), where f(t) is the temporal-bias factor, A is the aggressiveness factor, and t is the age of the item. In an embodiment, the decay function produces a value, f(t), where 0<f(t)≦1.

The aggressiveness factor can be chosen algorithmically at the time of calculating the rank score for the item or might be manually identified by an administrator. In an embodiment, one or more historical patterns are considered algorithmically to select the aggressiveness factor. The historical patterns are indicated by the user-engagement data or any other available data. The historical patterns might indicate time periods during which a particular item spikes in user-engagement and interest. The aggressiveness factor might thus be chosen at a more conservative value during the known historical spiking time period and might be chosen at a more aggressive value following such periods. Or when the historical patterns indicate that the spike in user-engagement is of short duration, a more aggressive value might be chosen. Conversely, a more conservative value might be chosen when historical patterns indicate a substantially constant level of user-engagement. Thus, in an embodiment, the decay function can be tailored to appropriately decay at a rate that most accurately reflects user interest in the item.

In an embodiment, the value of the aggressiveness factor is chosen so as not to false alarm or inject error into the ranking of items. For example, the value of the aggressiveness factor is chosen such that the decay function is not overly intense and is not inverted to produce growth instead of decay.

With continued reference to FIG. 3, a rank score is calculated for the item at a step 308. The rank score is calculated by, for example, the ranking component 212 or the search-engine server 206, using the user-engagement score and the temporal-bias factor. In an embodiment the user-engagement score is multiplied by the temporal-bias factor to calculate the rank score, however any other operations can be used to generate the rank score. The rank score may include any number of additional elements, parameters, variables, and other data for determining the rank score—the user-engagement score and temporal-bias factor may form just one element of a plurality of others that are included in the rank score calculation. For example, the rank score might include elements associated with paid items, performance data, and user-preference data among a variety of others. In an embodiment, the temporal-bias factor is also multiplied or otherwise used with one or more other variables in the rank score calculation.

As such, the temporal-bias factor decreases the effect of the user-engagement score on the rank score for the item with respect to the age of the item (when the value of the temporal-bias factor is less than 1). In other words, as the item ages the temporal-bias factor increasingly penalizes the user-engagement score. Thus, an older item that has accumulated a large amount of user-engagement data and that might have a high user-engagement score based on that accumulated data is penalized to reduce the effect of the user-engagement score on the rank score for the item. As such, newer items that have not had time to accumulate user-engagement data that would result in a higher user-engagement score are not penalized as much as the older items. The newer items thus have an opportunity to overcome the rank score of older items and be ranked above the older items.

Older items may have high user-engagement scores due to a large accumulation of user-engagement data. But such user-engagement data may also be old. Thus, it is possible for older item to become stale or of reduced user-interest but still remain in high ranking positions due to their high user-engagement scores. By penalizing such items using the temporal-bias factor, older items that have become stale can be moved down in the ranking, and newer fresh items that have high or increasing user interest can be promoted. And so the items selected for presentation in a search-engine results page can be kept fresh and up-to-date.

The items are ranked with respect to one another based on the rank score. And at a step 310, a number of the items are provided for presentation in a search-engine results page. In an embodiment, the highest ranked items are provided.

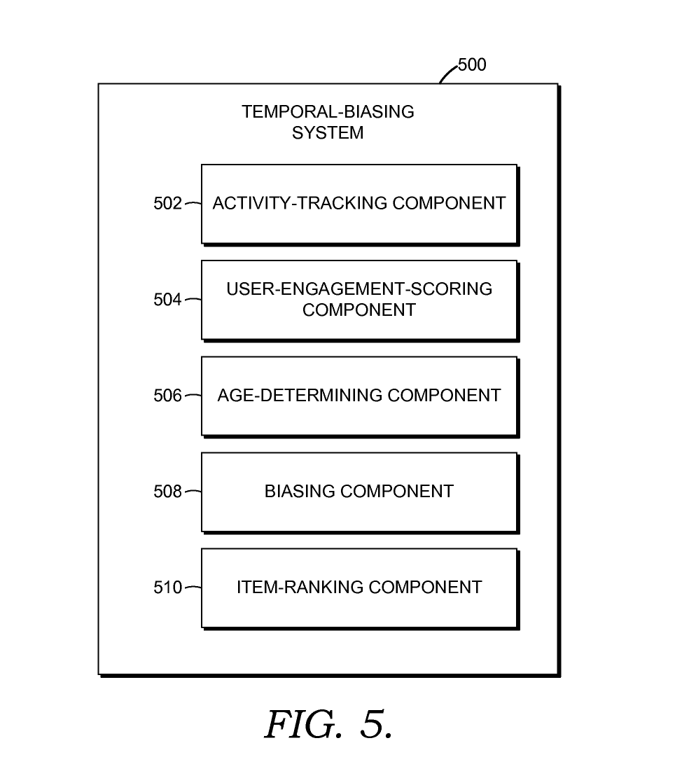

With reference now to FIG. 5, a temporal-biasing system 500 for increasing the freshness of items selected for inclusion in a search results webpage is described in accordance with an embodiment of the invention. The system 500 includes an activity-tracking component 502, a user-engagement-scoring component 504, an age-determining component 506, a biasing component 508, and an item-ranking component 510. The activity-tracking component 502 is configured to collect user-engagement data from a plurality users with respect to items with which the users interact. As described previously, the user-engagement data is descriptive of the users' web-browsing activities with respect to webpages, links therein, and the like. The user-engagement data may also include data regarding the users' web searching activities using a search engine, user preferences, or any other desirable data. Like the tracking component 210, the activity-tracking component 502 can be installed on the user's computing device, such as the user device 204, or can be executed on one or more networked computing devices. In an embodiment, the activity-tracking component 502 is the same as or is executed by the tracking component 210.

The user-engagement-scoring component 504 is configured to determine a user-engagement score based on collected user-engagement data for a particular item. The user-engagement score is based on any of the collected user-engagement data and may be determined with respect to time or a particular time period as described previously.

The age-determining component 506 is configured to determine an age of a particular item. The age might be based on a date when the system 500 first became aware of the item or might be based on metadata included in or with the item. The age can be determined in any units of time including hours, days, weeks, months, years, etc. In an embodiment, the age is determined in a unit corresponding to time periods over which the user-engagement score is calculated.

A temporal-bias factor is calculated by the biasing component 508. The temporal-bias factor is calculated using a decay function that provides a decaying or decreasing value of the temporal-bias factor with respect to the age of an associated item. In an embodiment, the decay function is an exponential decay function that includes an aggressiveness factor. The aggressiveness factor is selectable to adjust the rate or severity of the exponential decay output by the decay function as described previously.

The temporal-bias factor is used by the item-ranking component 510 to determine a rank score for the items. In an embodiment, the item-ranking component is the same as or is executed by the ranking component 212. The item-ranking component 510 uses the temporal-bias factor to adjust the effect that the user-engagement score has on the rank score for an associated item. The item-ranking component 510 can determine the rank score based only on the temporal-bias factor and the user-engagement score. In an embodiment, the user-engagement score is multiplied by the temporal-bias factor to penalize the user-engagement score as a function of the age of the item. The item-ranking component 510 might also use the temporal-bias factor and user-engagement score along with a plurality of other inputs and/or variables to determine the rank score.

The rank score is useable to rank the items with respect to one another. In an embodiment, the links are navigational links and are ranked against other navigational links that are included in the same webpage. In another embodiment, the items are advertisements, search results, or other items that can be included in a search-engine results page and that are included in an index. These items are ranked against other advertisements, search results, or items in the index that are identified by execution of a search query from a user.

The item-ranking component 510 provides the ranked items or indications of their rankings or rank scores to a search engine for inclusion in a search-engine results page. In an embodiment, the item-ranking component 510 provides only a highest ranking number of the items to the search engine.

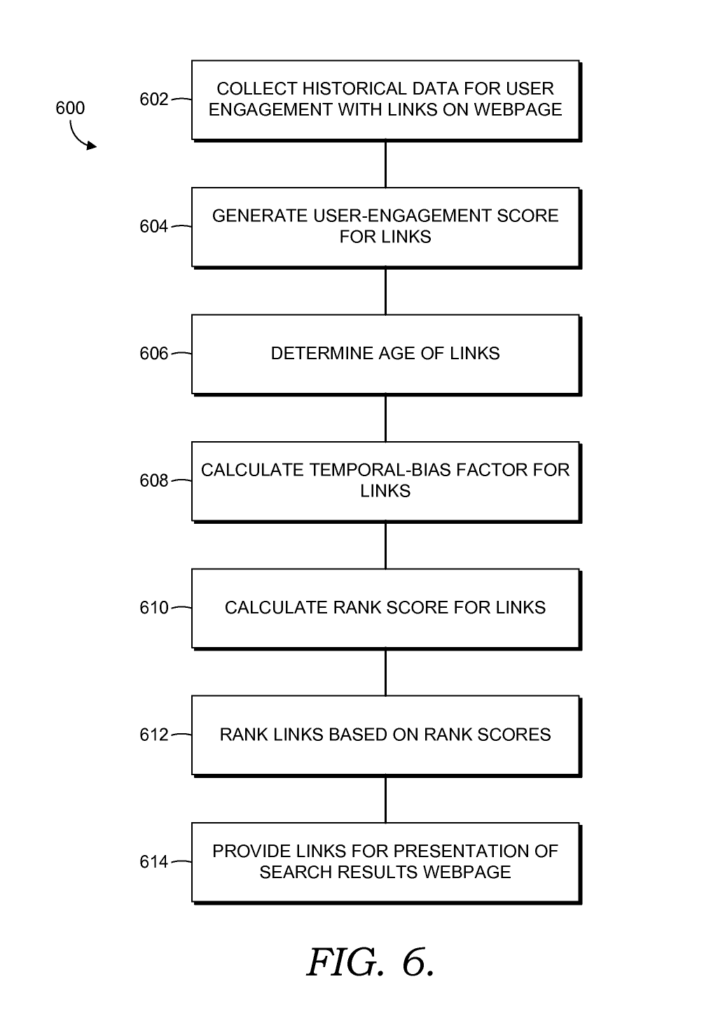

Referring now to FIG. 6, a method 600 for generating navigational links with temporal bias is described in accordance with an embodiment of the invention. At a step 602, data describing user engagement with navigational links on a webpage is collected. The user-engagement data includes, for example, a number of times users viewing the webpage click or select each of the navigational links in the webpage, an amount of time the users spend at the linked-to webpage that is accessed via the navigational links, whether the users click a back or return navigation button to return to the webpage from the linked-to webpage, and a number of times users access the webpage, among others.

A user-engagement score for each of the navigational links in the webpage is generated at a step 604. The user-engagement score may include a comparison of user-engagement data over different time periods, e.g. user-engagement over a most recent month versus user-engagement over a most recent year. This comparison can be used to identify a navigational link as trending upward, downward, remaining the same in popularity or user-engagement.

The age of each of the navigational links is determined at a step 606. A temporal-bias factor is calculated for each of the navigational links using an exponential decay function as indicated at a step 608. The decay function includes the age of the navigational link as a variable along with an aggressiveness factor that is useable to adjust the intensity of the decay function. A value for the aggressiveness factor is algorithmically chosen. The value of the aggressiveness factor is chosen based on one or more historical trends depicted in user-engagement data for the navigational links. The aggressiveness factor might also be chosen based on other data related to the navigational links or to other non-related items, market considerations, circumstances, or the like.

A rank score is calculated for each of the navigational links based at least in part on the user-engagement score and the temporal-bias factor. In an embodiment, the calculation of the rank score includes multiplying the user-engagement score by the temporal-bias factor. In another embodiment, the temporal-bias factor is multiplied with one or more other variables included in the rank score calculation. In an embodiment, a decay function is also employed to determine a biasing factor for one or more of the other variables in the rank score calculation.

Based on the rank score, the navigational links for the webpage are ranked against one another, as indicated at a step 612. The webpage, or a search result listing for the webpage, is subsequently identified for inclusion in a search-engine results page by a search engine. One or more of the navigational links are provided for presentation in the search-engine results page based on their ranking, as indicated at a step 614.

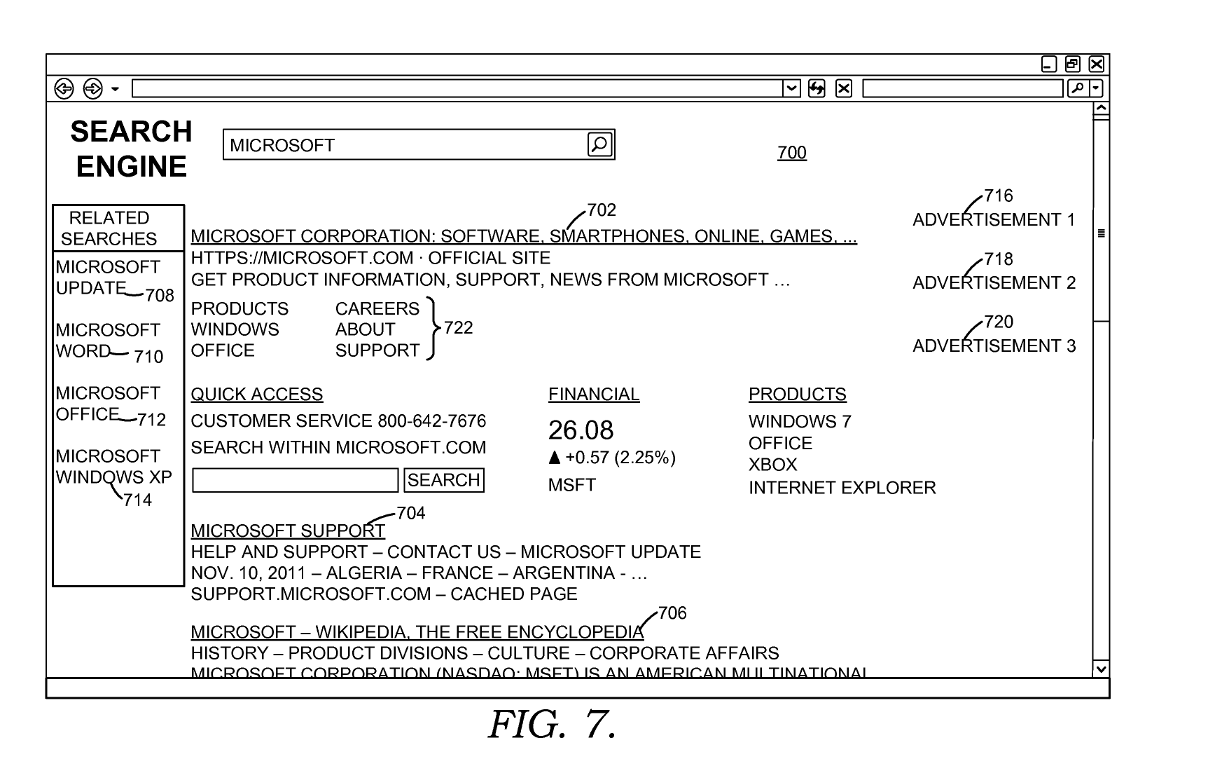

A graphical illustration of an exemplary search-engine results page 700 is depicted in FIG. 7. The exemplary search-engine results page 700 includes search result listings 702, 704, 706, related searches 708, 710, 712, 714, and advertisements 716, 718, and 720. The search result 702 includes a number of navigational links 722 that are presented in association with the search result 702. The navigational links 722 comprise links that are included in the webpage represented by the search result 702, e.g. the webpage located at “MICROSOFT.COM” includes navigational links that are labeled “PRODUCTS,” “WINDOWS,” “OFFICE,” “CAREERS,” “ABOUT,” and “SUPPORT.” By including the navigational links 722 with the search result 702 a user can simply select a desired navigational link 722 to go directly to the secondary webpage associated with the selected navigational link 722. In contrast, without the navigational links 722, the user would have to first select the search result 702 to be directed to the primary webpage associated with the search result 702. The user would then locate and select the desired navigational link in the primary webpage to access the associated secondary webpage.

The primary webpage associated with the search result 702 contains a plurality of navigational links therein—greater in number than the navigational links 722 that are provided with the search result 702. Thus, the navigational links 722 are ranked based on user engagement to identify those that are of most interest to users. This attempts to ensure that the navigational links 722 that are included with the search result 702 are the most used and/or desired by users. However, when a new navigational link is added to the primary webpage, there may not be sufficient user-engagement data to enable the new navigational link to obtain a great enough user-engagement score to be ranked and presented on the search-engine results webpage. This situation may be undesirable for example, when the new navigational link is to a new product that has great user-interest.

In such a situation, embodiments of the invention provide a temporal bias to enable new, fresh, trending navigational links to be promoted while older navigational links are penalized or demoted based on their age. Thereby, fresh navigational links 722 that have increasing or high user-engagement can be included in the search-engine results page in place of navigational links 722 that may be stale, decreasing in user interest, or that are old.

In another embodiment of the invention, a temporal-bias factor is calculated for one or more of search results, related searches, advertisements, or other items included in a search-engine results page, such as, the search results 702, 704, 706, related searches 708, 710, 712, 714, and advertisements 716, 718, and 720 of the search-engine results page 700. The temporal-bias factor is calculated based on user-engagement data collected for each of the search results, related searches, advertisements, or other items and a user-engagement score is calculated. As described above, the user-engagement score and the temporal-bias factors for each of the items are then useable as at least part of a calculation to determine a rank score for each of the items. The items can be ranked based on the rank score and selected for presentation in the search-engine results webpage.

Many different arrangements of the various components depicted, as well as components not shown, are possible without departing from the scope of the claims below. Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. One or more computer-readable storage media having computer-executable instructions embodied thereon that, when executed, perform a method of generating a temporal bias for an item in a search-engine results page, the method comprising:
generating a user-engagement score for an item in a search-engine results page;
determining an age of the item;
calculating a temporal-bias factor using a decay function;
calculate a rank score for the item based on the user-engagement score for the item and the temporal-bias factor;
ranking the item with a plurality of additional items based at least in part on the rank score; and
providing one or more of the item and the additional items for presentation on a search-engine results page.

2. The media of claim 1, wherein the item is one of a search result, an advertisement, a link, and a navigational link that is associated with a search result.

3. The media of claim 1, wherein the decay function is an exponential decay function that includes an aggressiveness factor (A) and the age of the item as variables.

4. The media of claim 3, wherein the decay function is of the form f(t)=1/(1+Ât), where f(t) is the temporal-bias factor, A is the aggressiveness factor, and t is the age of the link.

5. The media of claim 3, wherein the aggressiveness factor (A) has a value between 1.0 and 1.5.

6. The media of claim 1, wherein the decay function produces a temporal-bias factor that is a positive real number, x, where 0<x≦1.

7. The media of claim 1, wherein multiplying the user-interest score for the item by the temporal-bias factor to produce the rank score for the item decreases the rank score as a function of the age of the item and decreases the effect that historical user-engagement with the item has on ranking the item.

8. The media of claim 1, wherein the user-engagement score is determined based on user-engagement data for one or more periods of time.

9. The media of claim 8, wherein the user-engagement score is based on a statistical comparison of the user-engagement data for a previous year and for a previous month or week.

10. The media of claim 8, wherein the user-engagement data is collected by tracking web-browsing activities of a plurality of users.

11. The media of claim 10, wherein the web-browsing activities include one or more of clicks on links, impressions of links, duration of time spent at a linked-to webpage, and clicks on a back-navigation button.

12. A system for increasing freshness of items selected for inclusion in a search-engine results page, the system comprising one or more computing devices having a processor and executing:
a user-engagement scoring component that determines a user-engagement score for an item based on user-engagement data that is collected by tracking web-browsing activities of a plurality of users;
an age-determining component that determines an age of the item based on one or more of a time that the item was first published and a time the item was last updated;
a biasing component that calculates a temporal-bias factor for the item using a decay function that increases an intensity of the temporal-bias factor with respect to the increasing age of the item;
a ranking component that determines a rank score for the item based on the user-engagement score and the temporal-bias factor and ranks the item with a plurality of additional items based at least in part on rank score.

13. The system of claim 12, wherein the item is one of a search result, an advertisement, a link, and a navigational link that is associated with a search result.

14. The system of claim 12, wherein the decay function is an exponential decay function that includes an aggressiveness factor (A) and the age of the item as variables, and wherein the aggressiveness factor (A) is selected based a historical pattern of user-engagement.

15. The system of claim 12, further comprising:
a tracking component that tracks the web-browsing activities of the plurality of users, the web-browsing activities including one or more of clicks on items, impressions of items, a duration of time spent at a linked-to webpage, and clicks on a back-navigation button.

16. One or more computer-readable storage media having computer-executable instructions embodied thereon that, when executed, perform a method of generating navigational links with temporal bias, the method comprising:
collecting data depicting user engagement with a plurality of navigational links included in a first webpage;
generating a user-engagement score for each of the links;
determining an age of each of the links;
calculating, for each of the links, a temporal-bias factor using a decay function that includes the age of the link as a variable in the function;
calculating a rank score for each link based on the user-engagement score for each link and the respective temporal-bias factor;
ranking the plurality of links based at least in part on their respective rank scores; and
providing one or more of the links for presentation on a search-engine results page in association with a search result for the first webpage.

17. The media of claim 16, wherein the temporal-bias factor has a value x, where 0<x≦1.

18. The media of claim 16, wherein the decay function is an exponential decay function.

19. The media of claim 16, wherein the decay function is of the form f(t)=1/(1+Ât), where f(t) is the temporal-bias factor, A is an aggressiveness factor, and t is the age of the link.

20. The media of claim 19, wherein the value of the aggressiveness factor, A, is algorithmically selected based at least in part on a historical trend in user engagement with a given link.
